(19) United States
(12) Patent Application Publication
(10) Pub. No.: US 2026/0132926 A1
(43) Pub. Date: May 14, 2026

(54) SYSTEMS AND METHODS FOR BATTERY POWERED CONTROL OF A COOKING DEVICE

(71) Applicant: Loco - Crazy Good Cookers, Inc., Columbus, GA (US)

(72) Inventors: Qin QINGKUN, Panyu (CN); Blake K. LEVIEN, Katy, TX (US); McDonald PLUMMER, III, Milton, GA (US); Chau Nam WAI, Kennedy Town (HK); Joseph MAIORANA, Katy, TX (US); Joseph London TURNER, Butler, GA (US)

(21) Appl. No.: 19/118,062

(22) PCT Filed: Oct. 9, 2022
(86) PCT No.: PCT/CN2022/124205

§ 371 Date: Apr. 3, 2025

(51) Int. Cl. F24C 3/12; A47J 36/32; A47J 37/07; G05D 23/19

(52) U.S. Cl. CPC F24C 3/12; A47J 36/32; A47J 37/0786; G05D 23/1917

(57) ABSTRACT

Systems, methods, and devices include a battery powered cooking system (100). The cooking system (100) generally includes a battery (192) having power connection elements and a battery interface (190) including connection elements configured to make electrical connection with a first subset of the power connection elements of the battery (192), the connection elements of the battery interface (190) being connected to the first subset of power connection elements of the battery (192). The cooking system (100) may also include a digital control system (104) coupled to the battery interface (190) and configured to control heating operations of the cooking device (102) using power obtained from the battery interface (190).

### BACKGROUND

Cooking devices such as grills, griddles, or smokers are owned by many households and used in a variety of environments. For example, cooking devices may be placed anywhere outdoors such as in a backyard, or in some cases, taken to events held at parks or other outdoor open areas.

Operating these cooking devices comes with various challenges such as issues with temperature regulation and compensating for unlevel terrain. For instance, gas griddles create a variety of engineering challenges to manage the high heat cycles the grills endure while controlling the heat of the cooking surface. Heat often escapes from the portion of the griddle used for cooking and causes external components to overheat and become unsafe to touch. Over time, the escaped heat can also cause the supporting structures and additional components of the cooking device to warp. It is with these observations in mind, among others, that the presently disclosed technology was conceived.

### BRIEF SUMMARY

The presently disclosed technology addresses the foregoing problems by providing systems, devices, and methods for battery powered control of a cooking device. The cooking device can include a battery interface including connection elements configured to make electrical connection with a first subset of power connection elements of a battery when the battery is connected to the battery interface, and a digital control system coupled to the battery interface and configured to control heating operations of the cooking device using power obtained from the battery interface.

Some aspects provide a method for operating a cooking device. The method generally includes obtaining power from a battery interface including connection elements making electrical connection with a first subset of power connection elements of a battery, and controlling, via a digital control system, heating operations of the cooking device using the power obtained from the battery interface.

Some aspects include a cooking system. The cooking system generally includes a battery having power connection elements, a battery interface including connection elements configured to make electrical connection with a first subset of the power connection elements of the battery, the connection elements of the battery interface being connected to the first subset of power connection elements of the battery, and a digital control system coupled to the battery interface and configured to control heating operations of the cooking device using power obtained from the battery interface.

### BRIEF DESCRIPTION OF THE DRAWINGS

FIG. 1 illustrates an example system including a griddle device, in accordance with certain aspects of the present disclosure.

FIG. 2A illustrates an example system including a digital control system for regulating heat distribution and temperature, in accordance with certain aspects of the present disclosure.

FIG. 2B illustrates example configurations of battery interfaces for different types of cooking devices, in accordance with certain aspects of the present disclosure.

FIG. 3 illustrates a method for controlling a heat distribution for a cooking device, in accordance with certain aspects of the present disclosure.

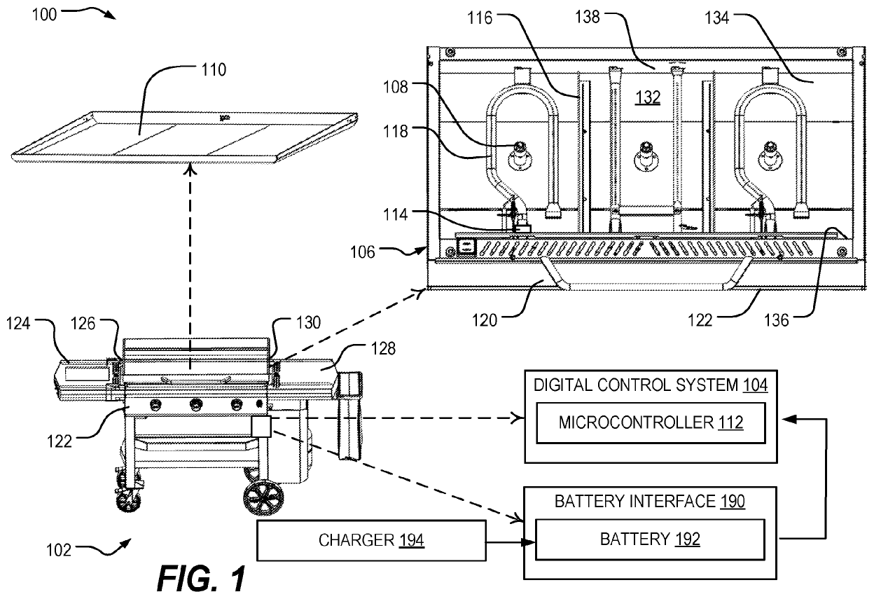

Any of the example systems or methods illustrated in FIGS. 1, 2A, 2B, and 3, or the components or operations thereof, can be combined together.

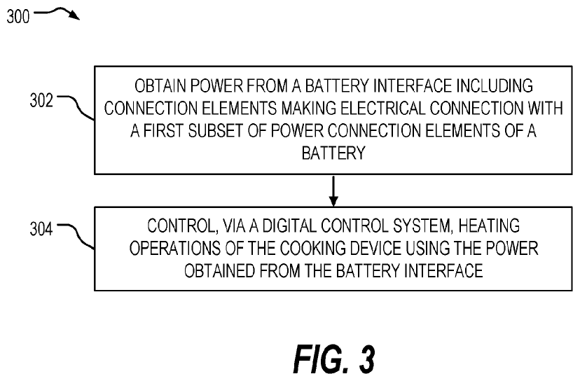

It is to be understood that the specific order or hierarchy of operations in the method 300 depicted in FIG. 3 and throughout this disclosure are instances of example approaches and can be rearranged while remaining within the disclosed subject matter.

### DETAILED DESCRIPTION

Systems disclosed herein improve upon previous techniques for controlling a cooking device, such as a griddle or grilling device, using a heat management system and a digital control system using a battery. The cooking device may be for outdoor use where convenient access to an alternating current (AC) power source may not be available. The cooking device may operate with a control system that requires power to operate and control various functions of the cooking device. Thus, a user may have to find a source of power for the cooking device while outdoors, which may be inconvenient. Certain aspects of the present disclosure are directed towards a cooking device with an interface for receiving a battery that powers the control system of the cooking device. In some aspects, the battery may be configured to operate with various types of cooking devices with varying power requirements (e.g., 5 or 12 volt power). For instance, the battery may be implemented to output different voltages at different pins. Each interface of different types of cooking devices may be configured to connect to the connection elements that provide the associated voltage for the type of cooking device. For instance, a griddle may have an interface that, when receiving a battery, connects the control system of the griddle to a ground pin and a 5 volt pin on the battery. On the other hand, a grilling device may have an interface that, when receiving a battery, connects the control system of the grilling device to the ground pin and a 12 volt pin on the battery.

FIG. 1 illustrates an example system 100 including a griddle device 102 to provide dynamic temperature control and even heat distribution using a digital control system 104 and a heat management system 106. While certain examples provided herein are described with respect to a griddle device to facilitate understanding, the battery power control system of the present disclosure may be implemented for any cooking device such as a grilling device or a smoker. The digital control system 104 can include a plurality of temperature sensors 108 (e.g., surface temperature sensors) in contact with a griddle top 110 and communicatively coupled to a microcontroller 112. As illustrated, the system 100 may include a battery interface 190 which may be configured to receive a battery 192. In some aspects, the battery 192 may have various pins configured to provide power at different voltages. The interface for the griddle device 102 may be configured to connect to pins that provide the appropriate voltage for operating the griddle device 102. The battery interface 190 may be coupled to the digital control system 104 in order to provide power from the battery 192 to the digital control system 104.

In some aspects, the system 100 may include a charger 194. The charger 194 may be integrated as part of the griddle device 102 or a separate charger provided to charge the battery 192. When integrated as part of griddle device 102, the charger 194 may charge the battery 192 while the battery is inserted into the battery interface 190. Alternatively, the battery 192 may be removed from the battery interface 190 and charged using the charger 194 separately. The charger 194 may receive AC power and provide voltage regulation to facilitate the charging of the battery 192.

As described, the digital control system 104 can include a plurality of temperature sensors 108. The temperature sensor(s) 108 can be spring-loaded sensors that touch a bottom surface of the griddle top 110 to provide temperature data readings to the microcontroller 112 which, in turn, calculates a griddle temperature value. The griddle temperature value can be compared to one or more stored temperature parameter values, and based on this comparison, the microcontroller 112 can actuate one or more gas valve(s) 114 providing gas to one or more burner(s) 118 (e.g., primary burners) to activate and/or adjust their flame height and the corresponding heat distribution of the griddle top 110. The internal structure housing the temperature sensors 108 and the burner(s) 118 (e.g., the primary burners and/or pilot burners) can be the heat management system 106, including one or more partitions 116 and/or heat distribution features. The heat management system 106 can include panels or sheets of metal that divide or separate the internal volume containing the temperature sensors 108 and underside burner(s) 118, while also insulating the internal space from the cooler exterior and external components (e.g., with insulating shieldings), and providing structural support for the griddle device 102. The heat management system 106, combined with the dynamic activations of the digital control system 104, can reduce hotspots, improve the granularity of the temperature data readings, and distribute heat in a more even and effective manner.

In some examples, the griddle device 102 has a body 120 with a front surface 122, a back surface, a first side shelf 124 extending from a first side 126, and/or a second side shelf 128 extending from a second side 130. These components can form an exterior portion or housing of the griddle device 102, which can define an internal space containing at least part of the heat management system 106. For instance, the heat management system 106 can include an underbracing 132 forming a bottom surface and/or one or more partition(s) extending between the front surface 122 and the back surface (e.g., along a center line) and/or between the first side 126 and the second side 130. Moreover, a front shielding 136 can extend along (e.g., parallel to) the front surface 122, and one or more side or rear shieldings 138 can extend along the first side 126, the second side 130, and/or the back surface-further enclosing the interior space of the heat management system 106 (e.g., and operating as wire shieldings). In some instances, the shieldings are formed of or include a layer of an at least partially insulating material, such as a fiberglass panel or a fiberglass cloth. The enclosed interior space can be divided into one or more heat compartments 134 or zones by the partitions 116 and/or shieldings. The one or more partitions 116 divide the interior space of the body 120 into a plurality of rectangular heat compartments 134 below the griddle top 110, and the underbracing 132 can define a bottom of the plurality of rectangular heat compartments 134. The temperature sensors 108, burners 118, and/or gas valves 114 can be distributed between the different heat compartments 134, as discussed in greater detail below.

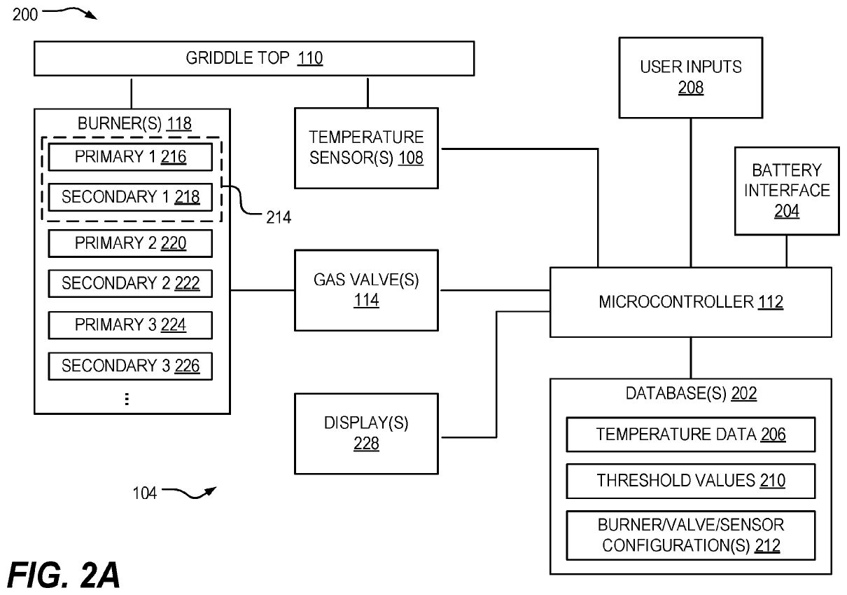

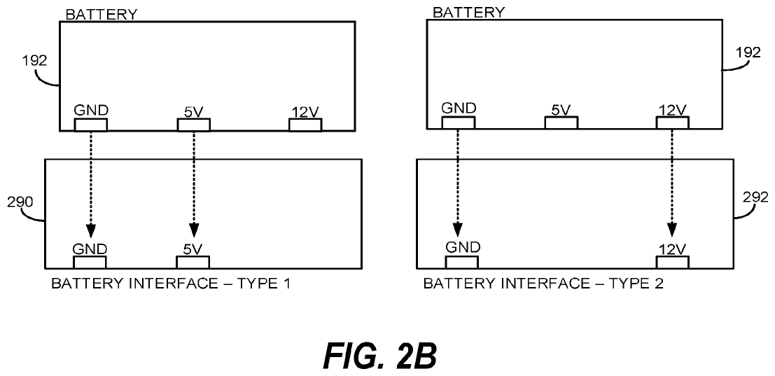

FIG. 2A illustrates an example system 200 including the digital control system 104 for regulating the heat distribution and griddle top surface temperature of the griddle device 102. The griddle device 102 can include the microcontroller 112 that retrieves, stores, and/or analyzes various data types from one or more database(s) 202. The system 200 can form at least a part of the system 100 depicted in FIG. 1.

In some examples, the digital control system 104 includes a battery interface 204 to provide power to the microcontroller 112, the temperature sensors 108, and/or any other electrical components of the griddle device 102. The battery interface 204 can include one or more batteries and implemented as a battery receptacle with a hinged door (e.g., disposed on one of the legs of the griddle device 102). The battery interface 204 may be configured to receive a lithium battery (e.g., a rechargeable lithium battery), although, any suitable type of battery may be implemented.

FIG. 2B illustrates example configurations of battery interfaces 290, 292 for different types of cooking devices such as a griddle or grill, in accordance with certain aspects of the present disclosure. As shown, the battery interface 290 may include a connection element for ground and a connection element for receiving 5 volt power. The battery 192 may include connection elements for ground, 5 volt power, and 12 volt power. While 5 and 12 volts are provided as examples to facilitate understanding, any voltages may be used as suitable for the associated cooking device. Once the battery 192 is inserted into the battery interface 190, the ground connection element of the battery 192 is electrically coupled to the ground connection element of the battery interface 290 and the 5 volt connection element of the battery 192 is electrically coupled to the 5 volt connection element of the battery interface 290, in effect providing 5 volt power to the cooking device (e.g., griddle).

On the other hand, a different type of cooking device (e.g., grill or smoker) may include the battery interface 292 with a connection element for ground and a connection element for 12 volt power. As shown, the same battery 192 may be inserted into either of the battery interfaces 290, 292. When the battery 192 is inserted into the battery interface 292, the ground connection element of the battery 192 is electrically coupled to the ground connection element of the battery interface 292 and the 12 volt connection element of the battery 192 is electrically coupled to the 12 volt connection element of the battery interface 292, in effect providing 12 volt power to the cooking device (e.g., grill or smoker).

Depending on the power consumption associated with different types of cooking devices, the battery 192 may provide power for different amounts of time before having to be recharged or replaced. For example, when implemented for the griddle, the battery may last for a longer time period than when implemented for a grill or smoker.

Referring back to FIG. 2A, the digital control system 104 can control the heat distribution to the griddle top 110 based on various data types received at the microcontroller 112 and/or stored at the database(s) 202. For instance, the griddle device 102 can receive temperature data 206 from the temperature sensor(s) 108. The temperature sensor(s) 108 can be one or more thermocouples coupled (e.g., welded) to a bottom surface (e.g., an underside) of the griddle top 110. Additionally or alternatively, the temperature sensors 108 can include one or more spring-loaded sensors that use the pressure generated by the springs to maintain contact with the bottom side of the griddle top 110 (e.g., as the griddle top 110 moves between a slanted position and a level position. The temperature sensors 108 can provide the temperature data 206 to the microcontroller 112 as a continuous data stream, periodically according to an upload schedule (e.g., once every second, two seconds, three seconds, five seconds, ten seconds, etc.), and/or in response to a user input 208, such as a temperature setting input. In some scenarios, the microcontroller 112 executes a data normalizing protocol to convert raw data or voltage values received from the temperature sensors 108 into temperature values corresponding to the heat distribution on the griddle top 110.

Additionally, the digital control system 104 can receive one or more input temperature setting values at the griddle device 102 indicating a desired temperature for the griddle top 110. The input temperature setting values can be received at a knob or dial (e.g., a digital dial) which can be disposed at a front panel of the griddle device 102. The digital control system 104 can convert the input temperature setting values into one or more threshold values 210, and can compare the temperature data 206 representing the current heat distribution on the griddle top 110 with the one or more threshold values 210. If the digital control system 104 determines the griddle temperature represented by the temperature data 206 is below the one or more threshold values 210, the microcontroller 112 can actuate or open one or more control features (e.g., the gas valves 114) to increase an amount of fuel provided to burner(s) 118. Likewise, the microcontroller 112 can actuate or close the gas valve(s) 114 in response to the griddle top temperature represented by the temperature data 206 being above the one or more threshold values 210. Once the temperature data 206 indicates that the griddle top temperature is within a range of the one or more threshold values 210 (e.g., and/or above or below a threshold value), the microcontroller 112 can shut off or at least partially close a primary valve associated with a primary burner of the one or more burners 118.

The digital control system 104 can open and close the gas valves 114 to regulate particularized gas flows to the different burners 118 in the different heat compartment 134 of the heat management system 106. For instance, the digital control system 104 can store data indicating a burner/valve/sensor configuration 212 to determine which temperature sensors 108 (e.g., and corresponding temperature data 206) are associated with which burners 118 and/or which heat compartment 134. In some examples, the microcontroller 112 can receive temperature data 206 from a temperature sensor 108 in a first heat compartment 214 to detect a portion of the heat distribution generated by a first primary burner 216 and/or a first secondary burner 218 also contained in the first heat compartment 214. The first heat compartment 214 can omit any other temperature sensors or burners, such that these components have a one-to-one correspondence with the first heat compartment 214. Additionally or alternatively the first heat compartment 214 can include a plurality of any of these components (e.g., multiple temperature sensors for higher granularity temperature readings, multiple burners for a high-heat area of the griddle top 110, or the like). Either way, the first heat compartment 214 can contain the components to particularize the heat distribution and the data collection for the first heat compartment 214 to a region of the bottom surface of the griddle top 110. By further subdividing the heat management system 106 with additional partitions 116 into arrays or lines of additional heat compartments similar or identical to the first heat compartment 214 (e.g., a line of three, four, five, six, etc., and/or a two-by-two array, a two-by-three array, a two-by-four array, a three-by-three array, etc.), the granularity of the heat distribution control and the data quality being collected can be increased. For instance, a second heat compartment can include a second primary burner 220 and a second secondary burner 222 and/or a second temperature sensor; a third heat compartment can include a third primary burner 224, a third secondary burner 226, and/or a third temperature sensor; and so on for any number of heat compartments 134 formed by the partitions 116. The partitions 116 forming the heat compartments 134 can extend across a middle of the internal space from the first side 126 to the second side 130 and/or from the front to the rear. Moreover portion of the partitions 116 may be formed by extensions down from the bottom surface of the griddle top 110.

The plurality of secondary burners can provide one or more pilot flame(s) (e.g., with a one-to-once correspondence to the heat compartments 134) and/or a smaller flame than the plurality of primary burners. In some instances, the plurality of primary burners and the plurality of secondary burners both include a gas distribution tube having a same size (e.g., include a same diameter, circumference, width, length, etc.), but can include a different gas dispersing feature. For instance, the primary burners may have a higher number of gas dispersing orifices and/or larger gas dispersing orifices than the secondary burners. Both the primary burners and the secondary burners can be a gas distribution tube extending from the front surface 122 to the back of the griddle device 102. One or more heat tents can be disposed over the plurality of secondary burners, for instance, to focus or disperse a portion of the heat distribution caused by the secondary burners (e.g., to create a low temperature zone on the griddle top 110 between 200° and 250°). In some examples, the griddle device 102 can detect if the secondary burner goes out for a predetermined amount of time (e.g., 5 seconds or longer) using a flame sensor, such as the temperature sensor(s) 108, a light sensor, and/or other sensors. Upon detecting that the secondary burner flame has gone out and the predetermined time has elapsed, the microcontroller 112 can actuate the gas valves 114 to stop providing fuel to the secondary burner, turning the secondary burner off. In response, the microcontroller 112 can generate an error message and/or receive a reset input (e.g., as the user input 208) to restart the secondary burner and cause fuel to flow and ignite from the secondary burner. Turning the gas valve 114 for the pilot flame off in response to detecting an absence of flame from the pilot burner improves safety for the griddle device 102 by preventing unintended combustions or explosions from a build-up of fuel expelled by an unlit secondary burner.

In some instances, the secondary burners can include various combinations of analog burners and/or pilot lights with a gas valve 114 between the analog burner and the fuel source. The analog burner(s) can be uncontrolled by the microcontroller 112. For instance, the analog burners can be used for an analog mode or a hybrid analog/digital mode with a first temperature set by the analog burners and a second temperature being achieved by adding the heat distribution from the digital burners using the techniques discussed herein. The griddle device 102 can be toggleable between the analog mode and a digital mode in response to the user input 208 received at the microcontroller 112.

In some instances, the digital control system 104 can store the burner/valve/sensor configuration 212 to maintain the different associations between the arrangement of heat compartments 134 and the corresponding gas burners 118 and temperature sensors contained within the heat compartments 134. The microcontroller 112 can, in some instances, use the open a primary valve on a primary line to adjust the fuel for the plurality of primary burners; and/or a secondary valve on a secondary line to adjust the fuel for the plurality of secondary burners. Additionally or alternatively, the microcontroller 112 can adjust one or more compartment line gas valves that provide fuel to an individual burner of particular heat compartments 134, repeatable for any sub-group of burners. For instance, the microcontroller 112 can open any of the gas valves for any heat compartments 134 corresponding to temperature data 206 indicating a griddle top temperature outside the range of threshold values 210 to keep the heat distribution on the griddle top 110 at that region consistent with other regions. The microcontroller 112 can do this automatically and continuously while the griddle device 102 is in use so that the different burner(s) 118 are constantly turning on and off at different regions of the griddle top 110 to maintain the consistent surface temperature. The different burners 118 and temperature sensors 108 separated into the different heat compartments 134 can form a row, an array, a ring, an irregular shape, or any other arrangement of heat compartments 134 within the body 120 of the griddle device 102. As such, the heat management system 106 can be used for a variety of different griddle devices 102 having different body shapes and sizes, and can provide a consistent heating temperature across the griddle top 110 while insulating the heat distribution from other components of the griddle device 102. The heat compartments 134 can provide more refined control over each of the heating compartments 134 or zones reducing heat spill-over from one zone to another. Each zone can be independently and/or automatically controlled to maintain the constant or changing temperature at the griddle top 110. The heat compartments 134 can heat an entire cooking area of the griddle top 110 with even heating, or portions of the griddle top 110 at various different heats using the heat management system 106. Moreover, the same components used for the heat management system 106 (e.g., the partitions 116, the underbracing 132, the insulating panels, etc.) can also add rigidity to the griddle device 102 to provide additional structural (e.g., lateral) support while preventing external components (e.g., the shelves) from getting too hot, thus improving safety and reducing warping.

Furthermore, in some instances, the heat management system 106 can include one or more insulating panels, insulating sheets, or insulating clothes. These insulating materials can separate the heat management system 106 from other components of the griddle device 102, such as the body 120, the heat sensitive portions of the digital control system 104, wiring, the first side shelf 124, the second side shelf 128, control dials, and the like. For instance, an insulating sheet of fiberglass cloth can be layered around an outer shell of the heat management system 106 and/or between a front panel including the control dials as well as the side walls of the body 120 of the griddle device 102. An insulating panel can be disposed over the bottom of underbracing 132, moreover, insulating panels and/or fabric can be disposed between any of the heat compartments 134 (e.g., and/or along the partitions 116). In this way, the heat distribution can be further regulated and controlled with high granularity and accuracy so hotspots can be reduced or created as desired, and the structural integrity of the griddle device 102 can be maintained.

In some examples, the digital control system 104 can include one or more display(s) 228. The display(s) 228 can be any type of light (e.g., light-emitting diodes (LED)) or display screens (e.g., touchscreen, Liquid Crystal Display (LCD), etc.). The display(s) 228 can be inset into a front panel of the griddle device 102 and/or formed into one or more rotating dials (e.g., digital dials or knobs connected to the microcontroller 112). For instance, the displays 228 can be formed into a middle or center portion of the knob, a top portion of the knob, and/or an outer portion of the knob. The display(s) 228 can show a current temperature of the top surface of the griddle top 110 based on the temperature data 206. Once the dial is rotated, the display(s) 228 can change to show the temperature setting input value, and can continue showing the temperature setting input value for 10 to 15 seconds until changing back to show the current measured temperature. The display(s) 228 can intermittently blink back-and-forth to show the desired set temperature value with the actual measured temperature. Furthermore, turning the dial a first direction (e.g., to the left) can turn the gas valve(s) 114 on and turning the dial a second direction (e.g., to the right) can turn the gas valve(s) 114 off using a graduated temperature scale that peaks at “sear” before turning off.

In some examples, the digital control system 104 forms at least a part of a computing system, including one or more hardware processors, one or more memory devices, and/or one or more ports, such as input/output (IO) port(s) and communication port(s).

The one or more hardware processor may include, for example, a central processing unit (CPU), a microprocessor, the microcontroller 112, a digital signal processor (DSP), and/or one or more internal levels of cache. The one or more hardware processor my comprises a single central-processing unit, or a plurality of processing units capable of executing instructions and performing operations in parallel with each other, commonly referred to as a parallel processing environment. Some embodiments of the presently described technology are optionally implemented in software stored on the data storage or memory device(s) and/or communicated via one or more of the ports to another computing device (e.g., a mobile device), thereby transforming the computing device of the digital control system 104 into a special purpose machine for implementing the operations described herein.

In some examples, the one or more memory device(s) may include any non-volatile data storage device capable of storing data generated or employed within the computing device, such as computer executable instructions for performing a computer process, which may include instructions of both application programs and an operating system (OS) that manages the various components of the computing device. The memory device(s) can store any of the database(s) 202 discussed above regarding FIG. 2A. The memory device(s) can include, without limitation, magnetic disk drives, optical disk drives, solid state drives (SSDs), flash drives, and the like. The memory device(s) may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) which may also be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device includes one or more ports, such as the I/O port and the communication port, for receiving inputs, and/or communicating with other computing devices or networks. It will be appreciated that the I/O port and the communication port may be combined or separate and that more or fewer ports may be included in the computing device. The I/O port may be connected to an I/O device, or other device, by which information is input to or output from the computing device. Such I/O devices may include, without limitation, one or more input devices, output devices, and/or environment transducer devices (e.g., a touchscreen, a button, the digital dial, etc.). The network(s) can include any type of network, such as the Internet, an intranet, a Local Area Network (LAN), a Wide Area Network (WAN), a Virtual Private Network (VPN), a Voice over Internet Protocol (VolP) network, a wireless LAN (e.g., Bluetooth, Wi-Fi), a wired network (e.g., ethernet, fiber, etc.) a cellular network (e.g., 4G, 5G, LTE, etc.), a satellite network, combinations thereof, etc. The griddle device 102 can include these various computing system components as part of the digital control system 104 and/or additionally in conjunction with the digital control system 104.

FIG. 3 illustrates a method for controlling a heat distribution for a cooking device. The method can be performed by at least the system 100 depicted in FIG. 1.

In some instances, at operation 302, the method 300 defines a cooking device obtaining power from a battery interface including connection elements making electrical connection with a first subset of power connection elements of a battery. In some aspects, the first subset of the power connection elements may include a first connection element for ground and a second connection element for a first voltage. The battery may further include a third connection element for a second voltage different than the first voltage. The battery interface may include a housing having a shape configured to removably couple the battery interface to the battery.

At operations 304, the cooking device may control, via a digital control system, heating operations of the cooking device using the power obtained from the battery interface. Controlling the heating operations may include controllably providing, via one or more valves (e.g., gas valves 114), a heating source for the cooking device using the power obtained from the battery interface. In some aspects, controlling the heating operations may include controlling, via a heat management system, a temperature associated with the cooking device using the power obtained from the battery interface.

In some aspects, the method 300 may also include displaying, via one or more displays, information associated with the cooking device. The one or more displays may be powered using power obtained from the battery interface.

In some aspects, the cooking device may receive, at a charging system, alternating current (AC) power, and charge, via the charging system, the battery using a direct current (DC) power generated using the AC power. The charging system may be coupled to the battery interface and configured to charge the battery via the battery interface.

It is to be understood that the specific order or hierarchy of operations in the method 300 depicted in FIG. 3 and throughout this disclosure are instances of example approaches and can be rearranged while remaining within the disclosed subject matter. For instance, any of the operations depicted in FIG. 3 and throughout this disclosure can be omitted, repeated, performed in parallel, performed in a different order, and/or combined with any other of the operations depicted in FIG. 3 and throughout this disclosure. Moreover, any of the example systems or methods illustrated in FIGS. 1, 2A, 2B, and 3, or the components or operations thereof, can be combined together.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A cooking device comprising:
a battery interface including connection elements configured to make electrical connection with a first subset of power connection elements of a battery when the battery is connected to the battery interface; and
a digital control system coupled to the battery interface and configured to control heating operations of the cooking device using power obtained from the battery interface.

2. The cooking device of claim 1, wherein:
the first subset of the power connection elements include a first connection element for ground and a second connection element for a first voltage; and
the battery further includes a third connection element for a second voltage different than the first voltage.

3. The cooking device of claim 1, wherein the battery interface comprises a housing having a shape configured to removably couple the battery interface to the battery.

4. The cooking device of claim 1, wherein the digital control system comprises one or more valves configured to controllably provide a heating source for the cooking device using the power obtained from the battery interface.

5. The cooking device of claim 1, wherein the digital control system comprises a heat management system configured to control a temperature associated with the cooking device using the power obtained from the battery interface.

6. The cooking device of claim 1, further comprising one or more displays for presenting information associated with the cooking device, wherein the one or more displays are powered using power obtained from the battery interface.

7. The cooking device of claim 1, further comprising a charging system configured to receive alternating current (AC) power and charge the battery using a direct current (DC) power generated using the AC power.

8. The cooking device of claim 7, wherein the charging system is coupled to the battery interface and configured to charge the battery via the battery interface.

9. A method for operating a cooking device, the method comprising:
obtaining power from a battery interface including connection elements making electrical connection with a first subset of power connection elements of a battery; and
controlling, via a digital control system, heating operations of the cooking device using the power obtained from the battery interface.

10. The method of claim 9, wherein:
the first subset of the power connection elements include a first connection element for ground and a second connection element for a first voltage; and
the battery further includes a third connection element for a second voltage different than the first voltage.

11. The method of claim 9, wherein the battery interface comprises a housing having a shape configured to removably couple the battery interface to the battery.

12. The method of claim 9, wherein controlling the heating operations includes controllably providing, via one or more valves, a heating source for the cooking device using the power obtained from the battery interface.

13. The method of claim 9, wherein controlling the heating operations includes controlling, via a heat management system, a temperature associated with the cooking device using the power obtained from the battery interface.

14. The method of claim 9, further comprising displaying, via one or more displays, information associated with the cooking device, wherein the one or more displays are powered using power obtained from the battery interface.

15. The method of claim 9, further comprising:
receiving, at a charging system, alternating current (AC) power; and
charging, via the charging system, the battery using a direct current (DC) power generated using the AC power.

16. The method of claim 15, wherein the charging system is coupled to the battery interface and configured to charge the battery via the battery interface.

17. A cooking system comprising:
a battery having power connection elements;
a battery interface including connection elements configured to make electrical connection with a first subset of the power connection elements of the battery, the connection elements of the battery interface being connected to the first subset of power connection elements of the battery; and
a digital control system coupled to the battery interface and configured to control heating operations of the cooking system using power obtained from the battery interface.
